(19) United States
(12) Patent Application Publication
(10) Pub. No.: US 2008/0102368 A1
(43) Pub. Date: May 1, 2008

(54) Battery Pack

(76) Inventors: Takashi Sumida, Osaka (JP); Hiroshi Maruyama, Osaka (JP); Masanori Yamakata, Osaka (JP)

Correspondence Address: BIRCH STEWART KOLASCH & BIRCH, PO BOX 747, FALLS CHURCH, VA, 22040-0747, US

(21) Appl. No.: 11/661,608

(22) PCT Filed: Nov. 17, 2005
(86) PCT No.: PCT/JP05/21141

§ 371 Date: Mar. 1, 2007

(30) Foreign Application Priority Data
Nov. 19, 2004 (JP) 2004-335459
Nov. 19, 2004 (JP) 2004-335460

(51) Int. Cl. H01M 2/00

(52) U.S. Cl. 429/178

(57) ABSTRACT

In a battery pack, a circuit board (10) has a plurality of external output terminals (3, 5) on the front, and a cover (16) has a plurality of openings (19, 20) that correspond to the external output terminals (3, 5) as through holes, respectively. A groove (29) filled with a resin mold (2) is formed at least between the adjacent openings (19, 20) in the back of the cover (16). A lead wire (13) is bent in a U-shape, and the curved portion (13a) of the lead wire (13) lies outside one end of the circuit board (10) in the lateral direction. A restraint member (31) is provided at the end (16a) of the cover (16) in the lateral direction. The restraint member extends backward from the end (16a) of the cover (16) to restrain the curved portion (13a) of the lead wire (13) from sticking out in the lateral direction.

### TECHNICAL FIELD

The present invention relates to a battery pack in which a circuit board is integrated with a unit cell by a resin mold.

### BACKGROUND ART

A battery pack has been used recently as a power supply of portable equipment. In such a battery pack, a circuit board having a plurality of external output terminals on the front is located in front of a unit cell, and a resin mold integrates the circuit board with the unit cell. For example, JP 2004-221026 A discloses a battery pack in which a circuit board is covered with a resin mold to protect electronic components on the circuit board, and this circuit board is integrated with a unit cell, while external output terminals to be connected to the contact terminals of external equipment are exposed on the front of the battery pack.

In the above battery pack, a negative terminal is provided on the front of the unit cell, and a strip lead wire connects the negative terminal and one end of the circuit board in the lateral direction. An outer can of the unit cell houses an electrode body and an electrolyte, and also serves as a positive terminal.

Moreover, a projection used for positioning of the battery pack that is mounted on external equipment may be formed on the front. However, sufficient strength of the projection cannot be obtained with a resin for the resin mold. Therefore, a high-strength resin cover may be produced separately to have such a projection on the front. This cover is located in front of the circuit board, and both the cover and the circuit board can be integrated with the unit cell by the resin mold.

The above battery pack is susceptible to leakage of the electrolyte from the unit cell due to improper use or the like. A structure to deal with the leakage problem has been proposed, e.g., by JP 2002-216721 A or JP 2000-311667.

If the electrolyte that has leaked from the unit cell is attached across the external output terminals, a short circuit may occur between the external output terminals. In particular, when the cover is located in front of the circuit board, the electrolyte tends to spread between the cover and the circuit board because of its capillary action. Consequently, the external output terminals are likely to be short-circuited.

In the above battery pack, after each end of the lead wire is joined to the negative terminal and one end of the circuit board, the lead wire is bent in a U-shape so that the circuit board is located in front of the unit cell. Therefore, the curved portion of the lead wire lies outside the circuit board in the lateral direction. If the curved portion of the lead wire sticks out excessively due to manufacturing errors or the like, it may come into contact with the inner surface of a die when an intermediate assembly is placed in the die before forming the resin mold. In this case, the negative terminal and the outer can (positive terminal) are short-circuited via the die, which can cause an abnormal rise in the internal pressure of the unit cell.

### DISCLOSURE OF INVENTION

A first battery pack of the present invention includes the following: a flat box-type unit cell having a connection terminal on the front; a circuit board located in front of the unit cell; a strip lead wire for connecting the connection terminal and one end of the circuit board in the lateral direction; a cover located in front of the circuit board; and a resin mold for integrating the circuit board and the cover with the unit cell. The circuit board has a plurality of external output terminals on the front. The cover has a plurality of openings that correspond to the external output terminals as through holes, respectively. A groove filled with the resin mold is formed at least between the adjacent openings in the back of the cover.

A second battery pack of the present invention includes the following: a flat box-type unit cell having a connection terminal on the front; a circuit board located in front of the unit cell; a strip lead wire for connecting the connection terminal and one end of the circuit board in the lateral direction; a cover located in front of the circuit board; and a resin mold for integrating the circuit board and the cover with the unit cell. The lead wire is bent in a U-shape, and the curved portion of the lead wire lies outside the one end of the circuit board in the lateral direction. A restraint member is provided at one end of the cover in the lateral direction. The restraint member extends backward from the one end of the cover to restrain the curved portion of the lead wire from sticking out in the lateral direction.

A third battery pack of the present invention includes the following: a flat box-type unit cell having a connection terminal on the front; a circuit board located in front of the unit cell; a strip lead wire for connecting the connection terminal and one end of the circuit board in the lateral direction; a cover located in front of the circuit board, and a resin mold for integrating the circuit board and the cover with the unit cell. The circuit board has a plurality of external output terminals on the front. The cover has a plurality of openings that correspond to the external output terminals as through holes, respectively. A groove filled with the resin mold is formed at least between the adjacent openings in the back of the cover. The lead wire is bent in a U-shape, and the curved portion of the lead wire lies outside the one end of the circuit board in the lateral direction. A restraint member is provided at one end of the cover in the lateral direction. The restraint member extends backward from the one end of the cover to restrain the curved portion of the lead wire from sticking out in the lateral direction.

### BRIEF DESCRIPTION OF DRAWINGS

FIG. 1 is a perspective view of a battery pack of the present invention.

FIG. 2 is a cross-sectional view taken along the line A-A in FIG. 1.

FIG. 3 is an exploded perspective view of a battery back of the present invention before forming a resin mold.

FIG. 4 is a perspective view of a front cover as seen from the front.

FIG. 5 is a perspective view of the front cover as seen from the back.

FIG. 6 is a cross-sectional view showing a state in which an intermediate assembly is placed in a die.

FIG. 7 is a plan view of the intermediate assembly.

FIG. 8 is a cross-sectional view taken along the line B-B in FIG. 6.

FIG. 9 is a cross-sectional view taken along the line C-C in FIG. 7.

### BEST MODE FOR CARRYING OUT THE INVENTION

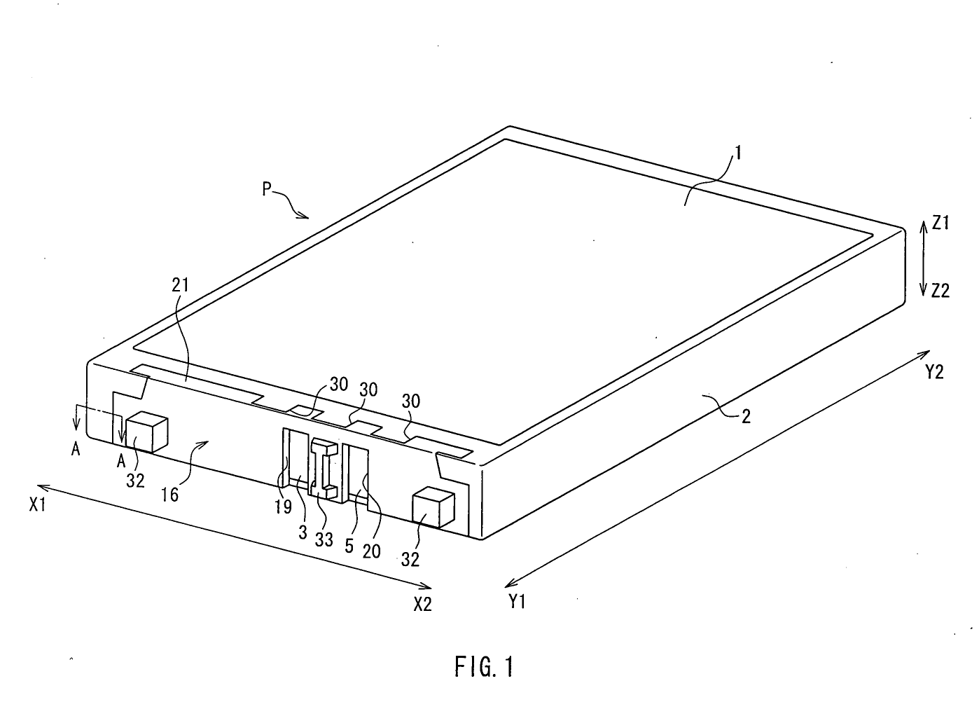

An embodiment of the present invention will be described with reference to FIGS. 1 to 9. In FIGS. 1 to 9, the same components are denoted by the same reference numerals: 1 is a unit cell; 2 is a resin mold; 3 and 5 are external output terminals; 6 is an outer can; 7 is a sealing plate; 9 is a negative terminal; 10 is a circuit board; 11 is a thermal fuse; 12 and 13 are lead wires; 13a is a curved portion; 14 and 18 are auxiliary lead wires; 15 is an intermediate assembly; 16 is a front cover; 16a is an end; 17 is a back cover; 19 and 20 are openings; 19a and 20a are frames; 21 is an upper engagement portion; 22 is a lower engagement portion; 23 is a lug; 25 is a protrusion; 26 and 27 are recesses; 29 is a groove; 30 is a notch; 31 is a restraint member; 31a is a front end; 32 and 33 are projections; 35 is a rib; 36, 37, and 39 are both-sided adhesive tapes; 40 is an adhesive tape; 41 is a first lower die; 43 is a slide core; 45 is a cavity; and P is a battery pack.

In this specification, the lateral (left and right), longitudinal (front and back), and vertical (up and down) directions are defined in principle as follows. As shown in FIG. 1, the X1-X2 line represents the lateral direction with X1 pointing to the left and X2 pointing to the right. The Y1-Y2 line represents the longitudinal direction with Y1 pointing forward and Y2 pointing backward. The Z1-Z2 line represents the vertical direction with Z1 pointing upward and Z2 pointing downward.

As shown in FIGS. 1 to 5, an example of a battery pack of the present invention includes a flat box-type unit cell 1 having a negative terminal 9 on the front, a circuit board 10 located in front of the unit cell 1, a strip lead wire 13 for connecting the negative terminal 9 and one end of the circuit board 10 in the lateral direction, a front cover 16 located in front of the circuit board 10, and a resin mold 2 for integrating the circuit board 10 and the front cover 16 with the unit cell 1.

The circuit board 10 has a plurality of external output terminals 3, 5 on the front. The front cover 16 has a plurality of openings 19, 20 that correspond to the external output terminals 3, 5 as through holes, respectively. A groove 29 into which a molten resin flows during the formation of the resin mold 2 is formed at least between the adjacent openings 19, 20 in the back of the front cover 16. The groove 29 is filled with the resin mold 2.

In this configuration, while the resin mold 2 is formed, a molten resin with good adhesive properties for molding the resin mold 2 flows into the groove 29 between the adjacent openings 19, 20. After the molten resin is set, the resin in the groove 29 makes firm contact with the front of the circuit board 10 and the inner surface of the groove 29 of the front cover 16, and thus can suppress the generation of a gap between them. Therefore, even if a liquid such as water droplets or an electrolyte that has leaked from the unit cell 1 is attached to either of the external output terminals 3, 5, it is possible to avoid a flow of the liquid through a gap between the front cover 16 and the circuit board 10 into the other external output terminal. This can prevent a short circuit between the external output terminals 3, 5 due to leakage of the electrolyte or the like.

The groove 29 may be formed so as to surround each of the openings 19, 20. Such grooves also prevent a liquid that leaks out between the front cover 16 and the circuit board 10 from flowing into the external output terminals 3, 5. Each of the openings 19, 20 may be surrounded either fully or partially (FIG. 5) by the groove 29.

The molten resin for molding the resin mold 2 may be a polyamide resin that exhibits good adhesion to both the circuit board 10 and the front cover 16. The polyamide resin may be nylon 6, etc.

The lead wire 13 is bent in a U-shape, and the curved portion 13a of the lead wire 13 lies outside the one end of the circuit board 10 in the lateral direction. A restraint member 31 is provided at the end 16a of the front cover 16 in the lateral direction. The restraint member 31 extends backward from the end 16a of the front cover 16 to restrain the curved portion 13a of the lead wire 13 from sticking out in the lateral direction.

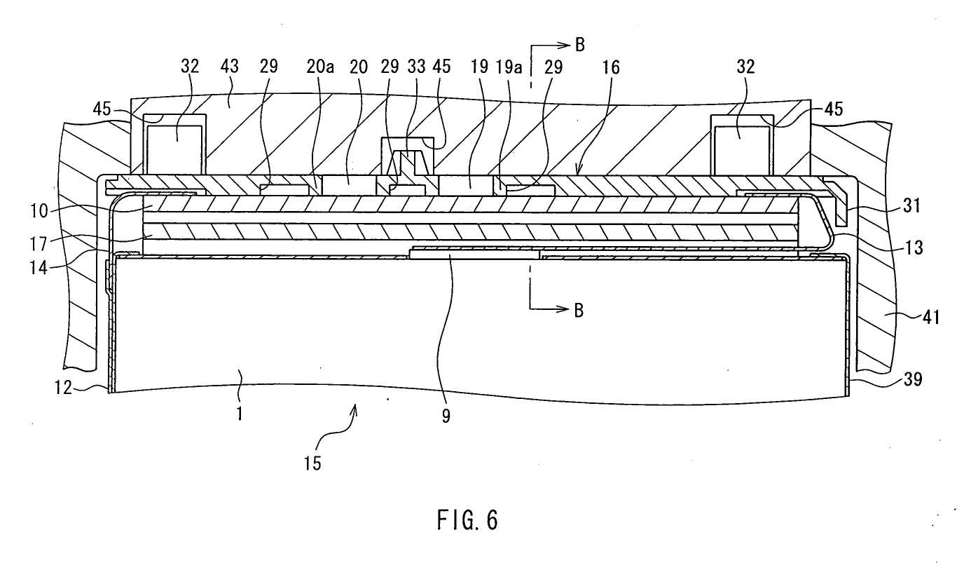

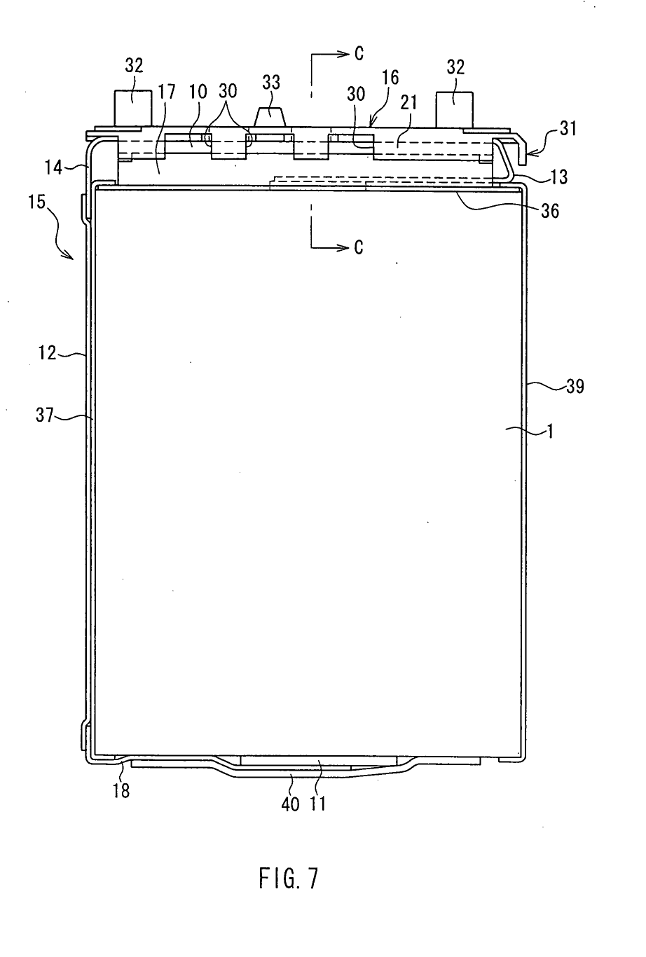

In this configuration, the restraint member 31 of the front cover 16 can restrain the curved portion 13a of the lead wire 13 from sticking out excessively away from the circuit board 10 in the lateral direction. Therefore, when an intermediate assembly 15 (FIG. 7) is placed in a first lower die 41 (FIG. 6) before forming the resin mold 2, it is possible to avoid contact of the curved portion 13a with the inner surface of the first lower die 41. This reliably can prevent a short circuit of the positive and negative electrodes of the unit cell 1 via the first lower die 41 during the formation of the resin mold 2. The intermediate assembly 15 and the first lower die 41 for molding the resin mold 2 will be described in detail later.

The end 16a of the front cover 16 is depressed backward to form a stepped portion. The front end 31a of the restraint member 31 is inclined with respect to the longitudinal direction. The resin mold 2 covers the end 16a of the front cover 16 and the front end 31a of the restraint member 31.

Since the front end 31a of the restraint member 31 is inclined with respect to the longitudinal direction, even if the front corners of the resin mold 2 are beveled and rounded, a sufficient thickness of the resin mold 2 can be ensured between the front end 31a of the restraint member 31 and the front corner of the resin mold 2. In addition to such a thickness of the resin mold 2, the end 16a of the front cover 16 is depressed backward. Therefore, the resin mold 2 is not interrupted by the restraint member 31, but formed continuously from the front end 31a of the restraint member 31 to the portion in front of the end 16a of the front cover 16. Thus, both sides of the front cover 16 can be held firmly with the resin mold 2. This reliably can prevent the front cover 16 from dropping off the battery pack P.

To fasten the front cover 16 temporarily on the front of the circuit board 10, as shown in FIG. 5, laterally long engagement portions 21, 22 that can be engaged with the back of the circuit board 10 are provided along the upper and lower edges of the front cover 16, respectively. Compared with temporary fastening of the front cover 16 by using a both-sided adhesive tape or the like, this configuration removes such a tape, and thus can reduce the number of components and man-hours needed for placement of the tape or the like.

At least one of the upper and lower engagement portions 21, 22 has a notch 30 through which a molten resin flows into the groove 29 during the formation of the resin mold 2. This configuration allows the molten resin to flow into the groove 29 reliably even in the presence of the engagement portions 21, 22.

The circuit board 10 may have only the external output terminals 3, 5 or a protection circuit other than the external output terminals 3, 5.

Hereinafter, the embodiment of the present invention will be described in detail based on FIGS. 1 to 9.

As shown in FIG. 1, the battery pack P includes the flat box-type unit cell 1, electrical components arranged on the sides of the unit cell 1, and the resin mold 2 for integrating the electrical components with the unit cell 1. The electrical components include the external output terminals 3, 5 facing outside.

In FIG. 1, the unit cell 1 is in the form of a flat rectangular box with substantially flat upper and lower surfaces, and the length of the unit cell 1 is shorter in the vertical direction than in the longitudinal and lateral directions. The resin mold 2 covers the electrical components, four sides of the unit cell 1, and part of the upper and lower surfaces of the unit cell 1. The resin mold 2 is made of a polyamide resin and not only insulates the electrical components from the outside, but also protects the electrical components and the unit cell 1.

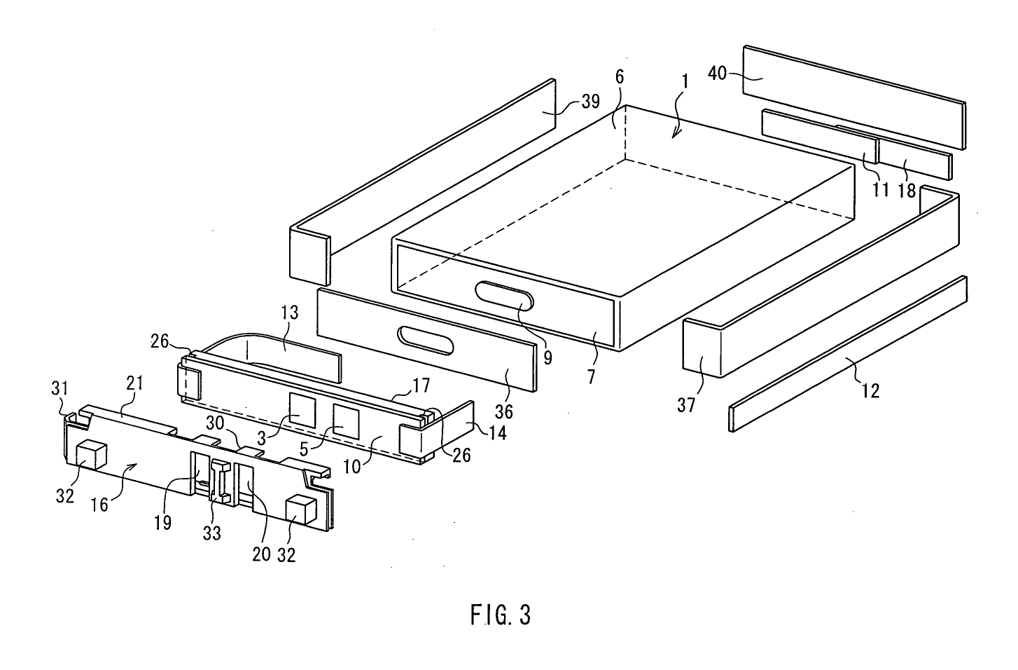

The unit cell 1 is a rechargeable secondary battery, specifically a lithium ion battery obtained by sealing an electrode body and an electrolyte in an outer can 6 in FIG. 3. A negative terminal 9 is provided in the center of a sealing plate 7 that closes the front of the outer can 6. The outer can 6 is formed by deep-drawing a sheet material of aluminum or its alloy. The sealing plate 7 is formed by press-working a sheet material of aluminum alloy or the like. The electrode body is produced in such a manner that a positive electrode sheet containing LiCoO₂ as an active material and a negative electrode sheet containing graphite as an active material are sandwiched together with a separator made of a synthetic resin, and then spirally wound and flattened.

The electrical components include the laterally long circuit board 10 located in front of the unit cell 1, a thermal fuse 11 located behind the unit cell 1, a long strip lead wire 12 located between the circuit board 10 and the thermal fuse 11, a short strip lead wire 13 for connecting the negative terminal 9 and the circuit board 10, an auxiliary lead wire 14 for connecting the circuit board 10 and the lead wire 12, and an auxiliary lead wire 18 for connecting the thermal fuse 11 and the lead wire 12. The short lead wire 13 is joined to the left end of the circuit board 10 and bent in a U-shape with its curved portion facing to the left. The long lead wire 12 is connected to the right end of the circuit board 10 via the auxiliary lead wire 14.

The circuit board 10 may include a protection circuit that controls a charge/discharge current of the unit cell 1. The external output terminals 3, 5 are arranged from side to side on the front of the circuit board 10 at the position slightly near to the right. The external output terminals 3, 5 are connected to the contact terminals of external equipment such as a portable telephone or charger, thereby performing input/output of a charge/discharge current with respect to the unit cell 1.

The thermal fuse 11 is used to interrupt the charge/discharge current of the unit cell 1 when the temperature of the unit cell 1 exceeds a set value. One end of the thermal fuse 11 is connected to the back of the outer can 6. The length of each of the circuit board 10 and the thermal fuse 11 is slightly shorter than that of the unit cell 1 in the vertical direction. The lead wires 12, 13 and the auxiliary lead wires 14, 18 are formed by cutting a thin conductive metal sheet of aluminum or the like in strips. The length of each of the lead wires 13, 14 and the auxiliary lead wires 14, 18 is shorter than that of the circuit board 10 in the vertical direction. The electrical components are assembled temporarily on the sides of the unit cell 1, resulting in an intermediate assembly 15 (FIG. 7). As will be described later, the resin mold 2 is formed on the intermediate assembly 15.

The electrical components also include the front cover 16 and a back cover 17 that sandwich the circuit board 10 in the longitudinal direction, as shown in FIG. 3. The front and back covers 16, 17 are laterally long and made of a polycarbonate resin that has excellent mechanical strength and insulating properties. The back cover 17 is present between the circuit board 10 and the unit cell 1 to insulate the circuit board 10 from the sealing plate 7 or the negative terminal 9.

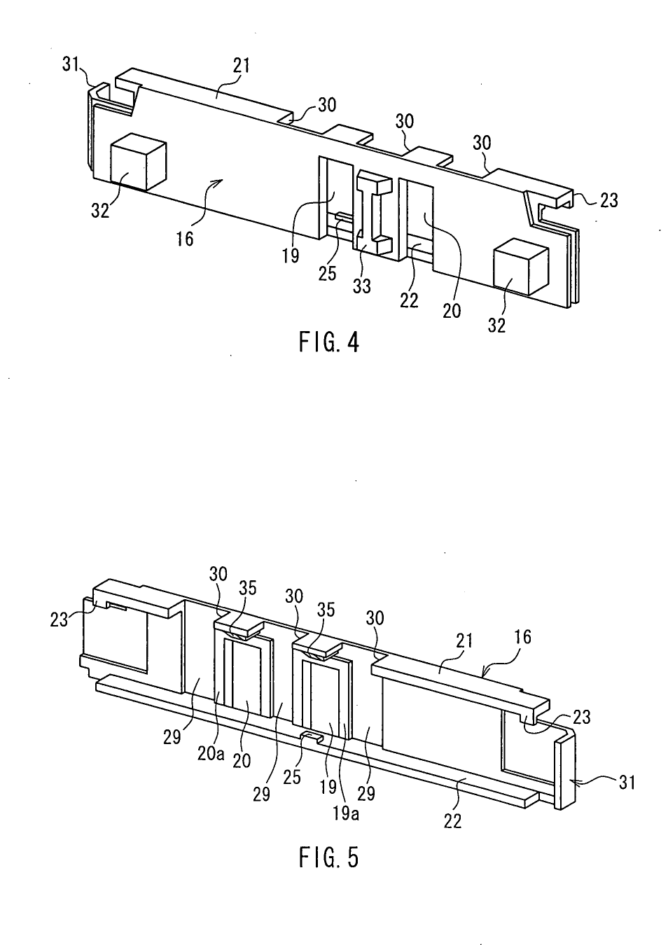

As shown in FIGS. 4 and 5, the front cover 16 has a pair of left and right openings 19, 20 corresponding to the external output terminals 3, 5 (FIG. 3) as through holes. Moreover, a pair of upper and lower engagement portions 21, 22 for fastening the front cover 16 temporarily on the front of the circuit board 10 is provided along the upper and lower edges of the front cover 16 in the longitudinal direction.

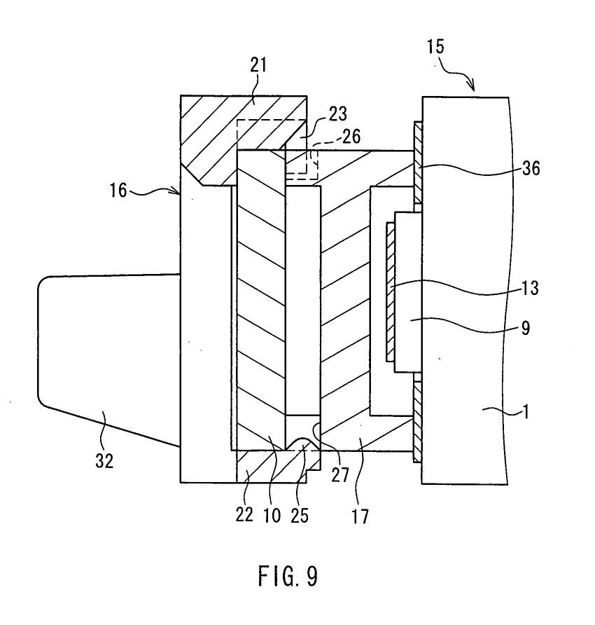

The engagement portions 21, 22 are formed over the entire upper and lower edges of the front cover 16. In the upper engagement portion 21, lugs 23, 23 are formed downward on both sides of the back edge. In the lower engagement portion 22, a protrusion 25 is formed upward in the center of the back edge. As shown in FIG. 9, the engagement portion 21 is engaged with the back of the circuit board 10 by fitting each of the lugs 23 into recesses 26 that are formed on both sides of the upper surface of the back cover 17. The engagement portion 22 is engaged with the back of the circuit board 10 by fitting the protrusion 25 into a recess 27 that is formed in the lower surface of the back cover 17.

As shown in FIG. 5, the grooves 29 into which a molten resin flows during the formation of the resin mold 2 are formed between the adjacent openings 19, 20, the left side of the opening 19, and the right side of the opening 20 in the back of the front cover 16. Each of the grooves 29 goes from the top to the bottom of the front cover 16 and extends above the openings 19, 20 so as to surround them. As shown in FIG. 4, the openings 19, 20 are cut into the front edge of the lower engagement portion 22. Moreover, frames 19a, 20a around the openings 19, 20 separate them from the grooves 29.

The upper engagement portion 21 has three notches 30 corresponding to the grooves 29, respectively. Each of the notches 30 is formed by cutting from the upper end of the groove 29 to the back edge of the engagement portion 21. While the resin mold 2 is formed, a molten resin flows into the grooves 29 through the notches 30.

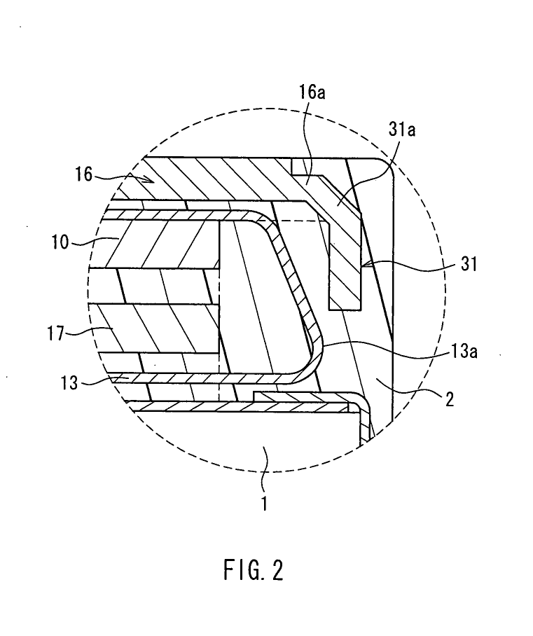

As shown in FIGS. 4 and 5, the plate-shaped restraint member 31 is provided at the end 16a (FIG. 2) of the front cover 16 that faces the curved portion 13a of the lead wire 13. The restraint member 31 extends backward from the end 16a of the front cover 16. As shown in FIG. 2, the restraint member 31 restrains the curved portion 13a of the lead wire 13 from sticking out to the left. Therefore, when the intermediate assembly 15 is placed in the first lower die 41 for molding the resin mold 2, the curved portion 13a of the lead wire 13 does not come into contact with the inner surface of the first lower die 41 (FIG. 6).

In FIG. 2, the front end 31a of the restraint member 31 is inclined with respect to the longitudinal direction. Thus, the resin mold 2 can have a predetermined thickness between the front end 31a of the restraint member 31 and the left (right in FIG. 2) front corner of the resin mold 2 that is rounded. The end 16a of the front cover 16 is depressed slightly backward to form a stepped portion, and the resin mold 2 covers the portion in front of the end 16a of the front cover 16. The resin mold 2 also has a predetermined thickness on the left side of the restraint member 31. Accordingly, both the restraint member 31 and the end 16a of the front cover 16 are covered with the resin mold 2, as shown in FIG. 2.

At the front of the front cover 16 in FIG. 4, for the purpose of positioning or the like when the battery pack P is mounted on external equipment, a pair of left and right projections 32, 32 in the form of a quadratic prism is formed on both sides, and an I-shaped projection 33 (as seen from the front) is formed between the openings 19, 20 in the longitudinal direction. As shown in FIG. 5, ribs 35, 35 are provided on the underside of the upper engagement portion 21 between each of the notches 30, 30. When the front cover 16 is fastened temporarily on the front of the circuit board 10, the ribs 35, 35 press the circuit board 10 against the lower engagement portion 22 to prevent the molten resin from passing through a gap between the circuit board 10 and the lower engagement portion 22 and reaching the front of the external output terminals 3, 5.

Next, an assembling procedure of the intermediate assembly 15 will be described. First, the auxiliary lead wire 14 is joined to the right end, and the short lead wire 13 is joined to the left end of the circuit board 10. Then, as shown in FIG. 3, an insulating both-sided adhesive tape 36 is bonded to the front of the sealing plate 7 of the unit cell 1, an insulating both-sided adhesive tape 37 is bonded to the right side of the unit cell 1, and a both-sided adhesive tape 39 is bonded to the left side of the unit cell 1. After the short lead wire 13 is joined to the negative terminal 9, the lead wire 13 is bent (FIG. 7) so that the circuit board 10 along with the back cover 17 is attached to the both-sided adhesive tape 36.

The thermal fuse 11 connected to the auxiliary lead wire 18 is joined to the back of the unit cell 1, and a heat-insulating adhesive tape 40 is bonded to the back of the thermal fuse 11. Subsequently, the auxiliary lead wire 18 is attached to the both-sided adhesive tape 37. Further, the auxiliary lead wire 14 connected to the circuit board 10 is attached to the both-sided adhesive tape 37. Finally, the long lead wire 12 is attached to the both-sided adhesive tape 37 to make a connection between the auxiliary lead wires 14, 18. The both-sided adhesive tape 39 reinforces the adhesion between the resin mold 2 and the left side of the unit cell 1.

Thereafter, the lugs 23 and the protrusion 25 of the front cover 16 are engaged with the back of the circuit board 10 (FIG. 9) while aligning the external output terminals 3, 5 of the circuit board 10 with the openings 19, 20 of the front cover 16. Consequently, the front cover 16 is fastened temporarily on the front of the circuit board 10, and the intermediate assembly 15 is provided as shown in FIG. 7.

The resin mold 2 is formed on the intermediate assembly 15 after first and second molding steps as follows.

First Molding Step

Referring to FIG. 6, the first molding step forms a first molding portion of the resin mold 2 by using a first upper die (not shown) and the first lower die 41. There is a space inside the first lower die 41 where the lower half of the intermediate assembly 15 is placed. There is a space inside the first upper die where the upper half of the intermediate assembly 15 is fitted and the first molding portion is formed. A slide core 43 is provided at the front of the first lower die 41 and can slide in the longitudinal direction. A pusher (not shown) is provided at the back of the first lower die 41 and pushes the intermediate assembly 15 in the space of the first lower die 41 forward.

The intermediate assembly 15 is placed in the first lower die 41 so that it is positioned in the lateral direction, but can be shifted in the longitudinal direction. In this state, the slide core 43 is moved backward, while the intermediate assembly 15 is pushed forward with the pusher, thereby bringing the front cover 16 into close contact with the inner surface of the slide core 43, as shown in FIG. 6. The intermediate assembly 15 is fixed in the first lower die 41 as a result of positioning in the longitudinal direction. The slide core 43 has cavities 45 that fit the projections 32, 33 of the front cover 16.

Next, the first upper die is joined and fixed to the first lower die 41. When the first lower die 41 and the first upper die are clamped together, the upper and lower surfaces of the intermediate assembly 15 are held between the two dies, and thus positioning is obtained. A molten resin is injected into the space of the first upper die to form a first molding portion of the resin mold 2 mainly around the electronic components and the four sides of the intermediate assembly 15 exposed in the space of the first upper die. In the first molding step, the resin mold 2 is formed mainly on one half of the intermediate assembly 15.

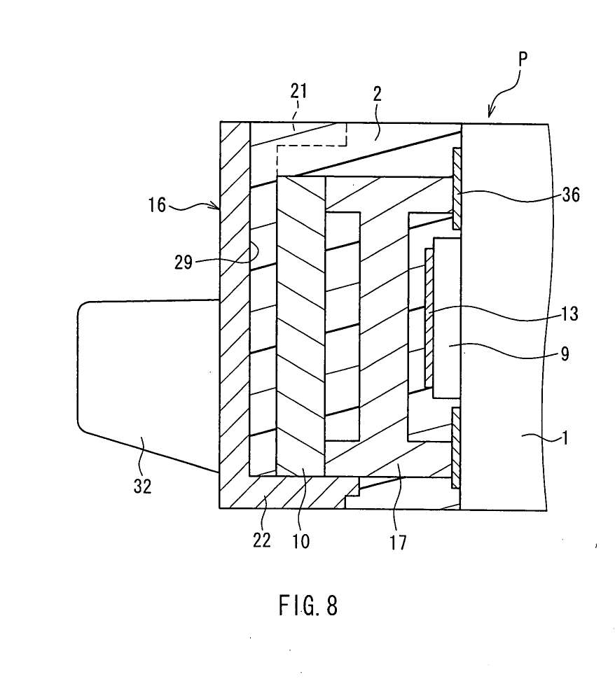

The molten resin flows into each of the grooves 29 through the notches 30 of the front cover 16 (FIG. 8). As shown in FIG. 6, the frames 19a, 20a of the openings 19, 20 are tightly in contact with the front of the circuit board 10. Therefore, the molten resin does not flow into the openings 19, 20 from the grooves 29.

The first molding portion is formed from the top to the bottom of the first lower die 41 not only on both sides of the circuit board 10 and the front cover 16, but also at both ends of the front of the front cover 16. After the molten resin is set, the first upper die is separated from the first lower die 41, and the intermediate assembly 15 with the first molding portion is taken out.

Second Molding Step

The second molding step forms a second molding portion of the resin mold 2 by using a second upper die and a second lower die (both are not shown). After the first molding step, the first molding portion of the intermediate assembly 15 is put in the second lower die, and positioning of the intermediate assembly 15 in the longitudinal and lateral directions is obtained by the inner walls that define a space inside the second lower die. Thus, the intermediate assembly 15 is fixed in the second lower die. Next, the second upper die is joined and fixed to the second lower die. In this state, a slide core provided at the front of the second upper die is moved backward to bring the inner surface of the slide core into close contact with the front cover 16. This slide core also has cavities that fit the projections 32, 33 of the front cover 16.

A molten resin is injected into a space of the second upper die to form a second molding portion of the resin mold 2 mainly around the electronic components and the four sides of the intermediate assembly 15 exposed in the space of the second upper die. In the second molding step, the resin mold 2 is formed mainly on the other half (i.e., a part on which the resin mold 2 is not formed in the first molding step) of the intermediate assembly 15. Thus, the resin mold 2 covering the four sides of the unit cell 1 and the electronic components is formed integrally. After the molten resin is set, the second upper die is separated from the second lower die, and the battery with the second molding portion is taken out of the second lower die, providing a product of the battery pack P. The upper and lower surfaces of the battery pack P are insulated with a seal or the like.

As shown in FIG. 8, the molten resin, which is a polyamide resin that exhibits good adhesion to the circuit board 10, flows into each of the grooves 29 of the front cover 16 in the first molding step. Therefore, when the molten resin is set, the polyamide resin in the grooves 29 makes firm contact with the front of the circuit board 10 and the inner surface of each of the grooves 29, and thus suppresses the generation of a gap between them. This can prevent an electrolyte that has leaked from the unit cell 1 from entering a gap between the front of the circuit board 10 and the wall between the openings 19, 20 of the front cover 16. Accordingly, no short circuit occurs between the external output terminals 3, 5 of the circuit board 10.

Moreover, the grooves 29 are formed so as to surround the openings 19, 20. This also can prevent a liquid that has leaked out in the vicinity of the openings 19, 20 from flowing between the front cover 16 and the front of the circuit board 10 into the external output terminals 3, 5.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

In a battery pack of the present invention, a liquid that has leaked out or the like does not flow between the circuit board and the cover, thereby preventing a short circuit between the adjacent external output terminals. Moreover, the curved portion of the lead wire does not come into contact with the inner surface of a die for molding the resin mold. Thus, it is also possible to prevent a short circuit between the negative and positive electrodes of the unit cell via the die.

1. A battery pack comprising:
a flat box-type unit cell having a connection terminal on a front;
a circuit board located in front of the unit cell;
a lead wire for connecting the connection terminal and one end of the circuit board in a lateral direction;
a cover located in front of the circuit board; and
a resin mold for integrating the circuit board and the cover with the unit cell,
wherein the circuit board has a plurality of external output terminals on a front,
the cover has a plurality of openings that correspond to the external output terminals as through holes, respectively, and
a groove filled with the resin mold is formed at least between the adjacent openings in a back of the cover.

2. The battery pack according to claim 1, wherein the groove is formed so as to surround each of the openings.

3. The battery pack according to claim 1, wherein laterally long engagement portions that can be engaged with a back of the circuit board are provided along upper and lower edges of the cover, respectively.

4. The battery pack according to claim 3, wherein at least one of the upper and lower engagement portions has a notch through which a molten resin flows into the groove during formation of the resin mold.

5. The battery pack according to claim 1, wherein the resin mold is made of a polyamide resin.

6. A battery pack comprising:
a flat box-type unit cell having a connection terminal on a front;
a circuit board located in front of the unit cell;
a lead wire for connecting the connection terminal and one end of the circuit board in a lateral direction;
a cover located in front of the circuit board; and
a resin mold for integrating the circuit board and the cover with the unit cell,
wherein the lead wire is bent in a U-shape, and a curved portion of the lead wire lies outside the one end of the circuit board in the lateral direction,
a restraint member is provided at one end of the cover in the lateral direction, and
the restraint member extends backward from the one end of the cover to restrain the curved portion of the lead wire from sticking out in the lateral direction.

7. The battery pack according to claim 6, wherein the one end of the cover is depressed backward to form a stepped portion, a front end of the restraint member is inclined with respect to a longitudinal direction, and the resin mold covers the one end of the cover and the front end of the restraint member.

8. The battery pack according to claim 6, wherein laterally long engagement portions that can be engaged with a back of the circuit board are provided along upper and lower edges of the cover, respectively.

9. The battery pack according to claim 8, wherein at least one of the upper and lower engagement portions has a notch through which a molten resin flows into the groove during formation of the resin mold.

10. A battery pack comprising:
a flat box-type unit cell having a connection terminal on a front;
a circuit board located in front of the unit cell;
a lead wire for connecting the connection terminal and one end of the circuit board in a lateral direction;
a cover located in front of the circuit board; and
a resin mold for integrating the circuit board and the cover with the unit cell,
wherein the circuit board has a plurality of external output terminals on a front,
the cover has a plurality of openings that correspond to the external output terminals as through holes, respectively, and
a groove filled with the resin mold is formed at least between the adjacent openings in a back of the cover, and
wherein the lead wire is bent in a U-shape, and a curved portion of the lead wire lies outside the one end of the circuit board in the lateral direction,
a restraint member is provided at one end of the cover in the lateral direction, and
the restraint member extends backward from the one end of the cover to restrain the curved portion of the lead wire from sticking out in the lateral direction.

11. The battery pack according to claim 10, wherein the groove is formed so as to surround each of the openings.

12. The battery pack according to claim 10, wherein laterally long engagement portions that can be engaged with a back of the circuit board are provided along upper and lower edges of the cover, respectively.

13. The battery pack according to claim 12, wherein at least one of the upper and lower engagement portions has a notch through which a molten resin flows into the groove during formation of the resin mold.

14. The battery pack according to claim 10, wherein the resin mold is made of a polyamide resin.

15. The battery pack according to claim 10, wherein the one end of the cover is depressed backward to form a stepped portion, a front end of the restraint member is inclined with respect to a longitudinal direction, and the resin mold covers the one end of the cover and the front end of the restraint member.
